(19) United States
(12) Patent Application Publication
(10) Pub. No.: US 2012/0081047 A1
(43) Pub. Date: Apr. 5, 2012

(54) CONTROL DEVICE OF A DRIVING APPARATUS

(75) Inventors: Hideki HISADA, Kawasaki (JP); Masami ISHIKAWA, Handa (JP)

(73) Assignee: AISIN AW CO., LTD., Anjo-shi (JP)

(21) Appl. No.: 13/225,099

(22) Filed: Sep. 2, 2011

(30) Foreign Application Priority Data
Sep. 30, 2010 (JP) 2010-222964

(51) Int. Cl. H02P 6/06

(52) U.S. Cl. 318/400.09

(57) ABSTRACT

A control device for a driving apparatus. The control device is configured with a device that controls the rotary electric machine via the inverter, a device that determines whether a disconnect condition of the main power supply is satisfied, and a device that obtains an estimated field amount that is an estimated value of the field flux supplied from the rotor to the stator. The control device is also configured with a device calculates an induced voltage that is induced in the coil, and a device that determines whether an overvoltage state in which the induced voltage exceeds a voltage resistance of the inverter exists. If it is determined that an overvoltage state exists when the disconnect condition is satisfied, connection with a main power supply is maintained until the overvoltage state is eliminated. The rotary electric machine is controlled by weakening the field flux to the coil.

### INCORPORATION BY REFERENCE

The disclosure of Japanese Patent Application No. 2010-222964 filed on Sep. 30, 2010 including the specification, drawings and abstract is incorporated herein by reference in its entirety.

### BACKGROUND OF THE INVENTION

The present invention relates to a control device of a driving apparatus that includes a variable magnetic flux-type rotary electric machine in which a field flux provided by a rotor having a permanent magnet can be adjusted, and a mechanism that adjusts this field flux.

### DESCRIPTION OF THE RELATED ART

Interior permanent magnet synchronous motors (IPMSM) that have a rotor with permanent magnets embedded inside of them are widely used. With an IPMSM, the permanent magnets are typically fixed to a rotor core, so the magnetic flux generated by the rotor is constant. The induced voltage generated in the stator coil becomes higher as the rotation speed of the rotor increases, and if the induced voltage exceeds the driving voltage, control may no longer be possible. To avoid this, field-weakening control that effectively weakens the magnetic field from the rotor is performed at a certain rotation speed or higher. However, when field-weakening control is performed, the current that flows through the stator coil increases with respect to the torque output from the rotary electric machine, so copper loss increases and efficiency decreases. Also, if the magnetic flux that reaches the stator from the permanent magnets remains constant, iron loss that occurs in the stator core also increases, and thus efficiency decreases, in the region where the rotation speed of the rotor is high.

Therefore, a variable magnetic flux-type rotary electric machine that changes the magnetic flux that reaches the stator from permanent magnets provided in a rotor according to the rotation speed of the rotor has been proposed. Japanese Patent Application Publication No. JP2002-58223A describes a rotary electric machine that has a radially outer rotor (100) and a radially inner rotor (200) that is housed to the radial inside of the radially outer rotor (100) (the reference numerals are from JP2002-58223A; the reference numerals from JP2002-58223A will be cited hereinafter in the description of the related art). The radially outer rotor (100) that rotates while facing an inner peripheral surface of a stator core (301) has permanent magnets (103) that create magnetic flux. The radially inner rotor (200) has an outer peripheral surface that faces the inner peripheral surface of the radially outer rotor, and is formed by a yoke or a magnetic rotor that is rotatably arranged. The relative phase in the circumferential direction of both rotors can be changed by a planetary reduction gear mechanism housed in a gear housing (4) (JP2002-58223A; paragraphs 27 to 37, FIGS. 1 to 3, Abstract, etc.).

Copper loss, iron loss, and inverter loss and the like are well-known losses that affect the efficiency of a rotary electric machine, so control to minimize these kinds of losses is preferably executed. A variable magnetic flux-type rotary electric machine such as that described above is able to suppress these losses, and thereby improve the efficiency of the rotary electric machine, by mechanically changing the field flux. A rotary electric machine is typically operated at low speed and high output (high torque), or at high speed and low output. In the case of the former, a strong field flux is required, and in the case of the latter, a weak field flux is required in order to suppress back electromotive force that accompanies the high speed. However, when seeking efficiency, there are cases in which a strong field flux is necessary even when operating at high speed. Also, a variable magnetic flux mechanism may fail and become fixed with a strong field flux. In such a case, field-weakening control that supplies a weakened field current to the stator coil may be executed while the field flux is strong.

If, for example, a rotary electric machine is used for a driving apparatus of a vehicle and an unexpected event occurs, e.g., a main power supply such as an ignition switch of a vehicle is turned off, while the rotary electric machine is being operated at high speed with a strong field flux, the control circuit including the inverter will also stop. The rotor of the rotary electric machine will continue to rotate from inertia, so regenerative electric power from the stator coil will be supplied to the inverter. At this time, when the rotor rotates within a strong field flux, induced voltage that exceeds the voltage of the direct current power supply of the inverter may be generated. The voltage resistance of the inverter is set to a realistic value that takes into account mechanical adjustment of the field flux, and field-weakening control that supplies a weakened field current to the stator coil and the like. More specifically, the voltage resistance of the inverter is set to a voltage that gives a predetermined margin to the direct current power supply of the inverter. Therefore, if induced voltage that greatly exceeds the power supply voltage of this direct current power supply is generated, the voltage resistance of the inverter may be exceeded, resulting in possible damage to the inverter. Also, if there is a problem with the mechanical field flux adjusting mechanism, such that the rotation speed of the rotary electric machine becomes high without the field flux being reduced, induced voltage that exceeds the voltage resistance of the inverter may also be generated. While it is possible to increase the voltage resistance of the inverter or provide a voltage limiting circuit, these would lead to an increase in the circuit size as well as an increase in cost.

### SUMMARY OF THE INVENTION

Thus, the present invention provides technology capable of keeping induced voltage within a voltage resistance limit of an inverter, without increasing the size of a control device that controls a driving apparatus that includes a variable magnetic flux-type rotary electric machine.

In view of the problems described above, a control device of a driving apparatus according to a first aspect of the present invention controls a driving apparatus that includes a rotary electric machine provided with a rotor having a permanent magnet and a stator having a coil, a field adjusting mechanism that changes a field flux supplied by the rotor, and an inverter that is connected to the coil. The control device includes: a power supply input portion that is connected to a direct current main power supply; a power supply controlling portion that controls connection and disconnection between the power supply input portion and the main power supply; a rotary electric machine controlling portion that controls the rotary electric machine via the inverter; a disconnect condition determining portion that determines whether a disconnect condition of the main power supply is satisfied; a field amount deriving portion that obtains an estimated field amount that is an estimated value of the field flux supplied from the rotor to the stator; an induced voltage calculating portion that calculates an induced voltage that is induced in the coil, based on a rotation speed of the rotor and the estimated field amount; and an overvoltage determining portion that determines whether an overvoltage state in which the induced voltage exceeds a voltage resistance of the inverter exists, and if it is determined that the overvoltage state exists when the disconnect condition is satisfied, connection with the main power supply is maintained regardless of the disconnect condition, at least until the overvoltage state is eliminated, and the rotary electric machine is controlled by field-weakening control that supplies a weakened field current that weakens the field flux to the coil, and the main power supply is disconnected according to the disconnect condition after the overvoltage state has been eliminated.

According to the first aspect, if it is determined that the overvoltage state exists when the disconnect condition is satisfied, connection with the main power supply is maintained regardless of the disconnect condition, at least until the overvoltage state is eliminated. The connection with the main power supply is maintained, so the control device is able to control the rotary electric machine by field-weakening control that supplies a weakened field current that weakens the field flux to the coil. Therefore, even if an unexpected event occurs, e.g., if a condition that the connection with the main power supply be disconnected is satisfied, during high speed operation with a strong field flux, it is possible to inhibit high induced voltage from being generated by the rotor that continues to rotate from inertia. When the inertia force weakens and the rotation speed of the rotor decreases, the induced voltage also decreases. After the overvoltage state has been eliminated, the main power supply is disconnected according to the disconnect condition, so the main power supply can also be appropriately controlled. In this way, according to the first aspect, it is possible to keep the induced voltage within the voltage resistance limit of the inverter, without increasing the size of a control device of a driving apparatus that controls a driving apparatus provided with a variable magnetic field-type rotary electric machine.

Maintaining the connection with the main power supply before the disconnect condition is satisfied makes it possible to prepare for the disconnect condition to be suddenly satisfied. For example, when a failsafe mechanism that constantly controls the induced voltage so that it will not exceed the voltage resistance of the inverter is provided and an abnormality occurs in the failsafe mechanism or the field adjusting mechanism, it is preferable to prepare for the disconnect condition to be suddenly satisfied by maintaining the connection with the main power supply before the disconnect condition is satisfied. At this time, if there is an additional condition that it be determined that an overvoltage state exists, the connection with the main power supply will not be unnecessarily maintained. Even if it is determined that the overvoltage state exists, appropriate control is possible by field-weakening control or the like when the main power supply is turned on. However, if the disconnect condition is suddenly satisfied and the main power supply is disconnected, the field-weakening control or the like will not be able to be performed, so induced voltage that exceeds the voltage resistance of the inverter may be generated by the rotor that continues to rotate due to inertia. With respect to this, if the connection with the main power supply is maintained in anticipation, even if the disconnect condition is suddenly satisfied, the field-weakening control or the like can be continued, so the induced voltage can be suppressed.

According to a second aspect of the present invention, this kind of control device of a driving apparatus may further include an adjusting mechanism controlling portion that determines a field command value that serves as a target for the field flux that is adjusted by the field adjusting mechanism, based on at least the rotation speed of the rotor, with a field limiting value, that is set according to the rotation speed of the rotor within a range in which the induced voltage will not exceed the voltage resistance of the inverter, as an upper limit, and controls the field adjusting mechanism; and an abnormality determining portion that determines an abnormality in at least one of the adjusting mechanism controlling portion and the field adjusting mechanism. Here, when it is determined that the overvoltage state exists and it is determined by the abnormality determining portion that there is an abnormality, the power supply controlling portion may maintain the connection with the main power supply regardless of the disconnect condition.

According to a third aspect of the present invention, the rotary electric machine controlling portion of the control device of a driving apparatus according to the present invention may determine a current command that is a target value for a driving current supplied to the coil, based on at least the estimated field amount, a target torque of the rotary electric machine, and the rotation speed, and control the rotary electric machine. When the field flux is constant, the current command is typically determined based on the target torque and the rotation speed. However, the current command for outputting the target torque differs depending on the strength of the field flux, so it is preferably determined taking the strength of the field flux into account. According to the third aspect, the current command is determined based on the estimated field amount, the target torque, and the rotation speed. Therefore, a driving apparatus in which the field flux is not constant can be controlled better following the changing field flux.

Also, according to a fourth aspect of the present invention, the field adjusting mechanism of the control device of a driving apparatus according to the present invention may be a mechanism that adjusts the field flux by displacing at least a portion of the rotor in a circumferential direction or a direction of a rotational axis of the rotor, and may include a driving source that supplies driving force for the displacement, and a power transmitting mechanism that transmits the driving force from the driving source to the rotor. According to the fourth aspect, the field flux is adjusted by displacing at least a portion of the rotor, so the field flux can be adjusted without intermittently flowing weakened field current that reduces efficiency and the like.

Here, according to a fifth aspect of the present invention, the rotor may include a first rotor and a second rotor that each have a rotor core and of which a relative position is adjustable, and the permanent magnet may be provided in the rotor core of at least one of the rotors. Also, the field adjusting mechanism may be a relative position adjusting mechanism that adjusts the field flux by displacing the relative position in a circumferential direction. The circumferential direction of the rotor is the direction corresponding to an electrical angle, so the relative position (the relative phase) of the electrical angle of the two rotors can be changed by displacing the relative position of the two rotors in the circumferential direction. As a result, the magnetic circuit through which the magnetic flux of the permanent magnet passes changes, so the field flux supplied to the stator can be better adjusted.

Here, if the structure is one that approximates a gear mechanism that drivingly connects the first rotor and the second rotor together, a relative position adjusting mechanism as the field adjusting mechanism can be formed by a simple structure. According to a sixth aspect of the present invention, the first rotor and the second rotor may both be drivingly connected to a common output member; the relative position adjusting mechanism may include, as the power transmitting mechanism, a first differential gear mechanism that has three rotating elements, and a second differential gear mechanism that has three rotating elements; the first differential gear mechanism may have, as the three rotating elements, a first rotor connecting element that is drivingly connected to the first rotor, a first output connecting element that is drivingly connected to the output member, and a first stationary element; the second differential gear mechanism may have, as the three rotating elements, a second rotor connecting element that is drivingly connected to the second rotor, a second output connecting element that is drivingly connected to the output member, and a second stationary element; one of the first stationary element and the second stationary element may serve as a displaceable stationary element that is operatively linked to the driving source, and the other may serve as a non-displaceable stationary element that is held stationary by a non-rotating member; and a gear ratio of the first differential gear mechanism and a gear ratio of the second differential gear mechanism may be set such that a rotation speed of the second rotor connecting element and a rotation speed of the first rotor connecting element while the displaceable stationary element is held stationary are equal to each other.

The driving apparatus and the control device of a driving apparatus may be structured as one functional portion within a large system. At this time, it may not be preferable to have the control device of a driving apparatus that is one functional portion directly control the turning on and off of the main power supply of this system. Therefore, it is preferable to provide a bypass to be able to indirectly control the connection with the main power supply. As one preferred embodiment, a sub switch may be provided separate from a main switch that connects the power supply input portion to the main power supply when closed and disconnects the power supply input portion from the main power supply when open, and provided bypassing the main switch. The sub switch is capable of connecting the power supply input portion to the main power supply when closed regardless of an open/closed state of the main switch, may be provided. Here, the power supply controlling portion controls the sub switch closed regardless of the disconnect condition, when it is determined that the overvoltage state exists. As a result, the control device of a driving apparatus according to the present invention is able to maintain the connection with the main power supply regardless of the disconnect condition.

When a sub switch such as that described above is provided, it is possible to prepare for the disconnect condition to be suddenly satisfied by closing the sub switch before the disconnect condition is satisfied. For example, when a failsafe mechanism that constantly controls the induced voltage so that it will not exceed the voltage resistance of the inverter is provided and an abnormality occurs in the failsafe mechanism or the field adjusting mechanism, it is preferable to prepare for the disconnect condition to be suddenly satisfied by closing the sub switch before the disconnect condition is satisfied. At this time, if there is an additional condition that it be determined that an overvoltage state exists, the sub switch will not be closed unnecessarily. Even if it is determined that the overvoltage state exists, appropriate control is possible by field-weakening control or the like when the main power supply is turned on. However, if the disconnect condition is suddenly satisfied and the main power supply is disconnected, the field-weakening control or the like will not be able to be performed, so induced voltage that exceeds the voltage resistance of the inverter may be generated by the rotor that continues to rotate due to inertia. With respect to this, if the sub switch is closed in anticipation, even if the disconnect condition is suddenly satisfied, the field-weakening control or the like can be continued, so the induced voltage can be suppressed.

As a preferred embodiment, this kind of a control device of a driving apparatus may also include: an adjusting mechanism controlling portion that determines a field command value that serves as a target for the field flux that is adjusted by the field adjusting mechanism, based on at least the rotation speed of the rotor, with a field limiting value that is set according to the rotation speed of the rotor within a range in which the induced voltage will not exceed the voltage resistance of the inverter, as an upper limit, and controls the field adjusting mechanism; and an abnormality determining portion that determines an abnormality in at least one of the adjusting mechanism controlling portion and the field adjusting mechanism. Here, when it is determined that the overvoltage state exists and it is determined by the abnormality determining portion that there is an abnormality, the power supply controlling portion may control the sub switch closed regardless of the disconnect condition.

### BRIEF DESCRIPTION OF THE DRAWINGS

FIG. 1 is a block diagram showing a frame format of the overall structure of a driving apparatus and a control device thereof;

FIG. 2 is a flowchart illustrating an example of power supply control by the control device;

FIG. 3 is a flowchart illustrating an example of power supply control executed irrespective of whether a disconnect condition is satisfied;

FIG. 4 is a view showing a frame format of the relationship between a field limiting value and induced voltage according to rotation speed;

FIG. 5 is a torque map of a control region of each field flux provided with a field limit;

FIG. 6 is a flowchart illustrating an example of power supply control following an abnormality determination of field control;

FIG. 7 is a sectional view in the axial direction of the driving apparatus;

FIG. 8 is a skeleton view of a relative position adjusting mechanism; and

FIG. 9 is a block diagram showing a frame format of an example of another embodiment of a power supply circuit.

### DETAILED DESCRIPTION OF THE EMBODIMENTS

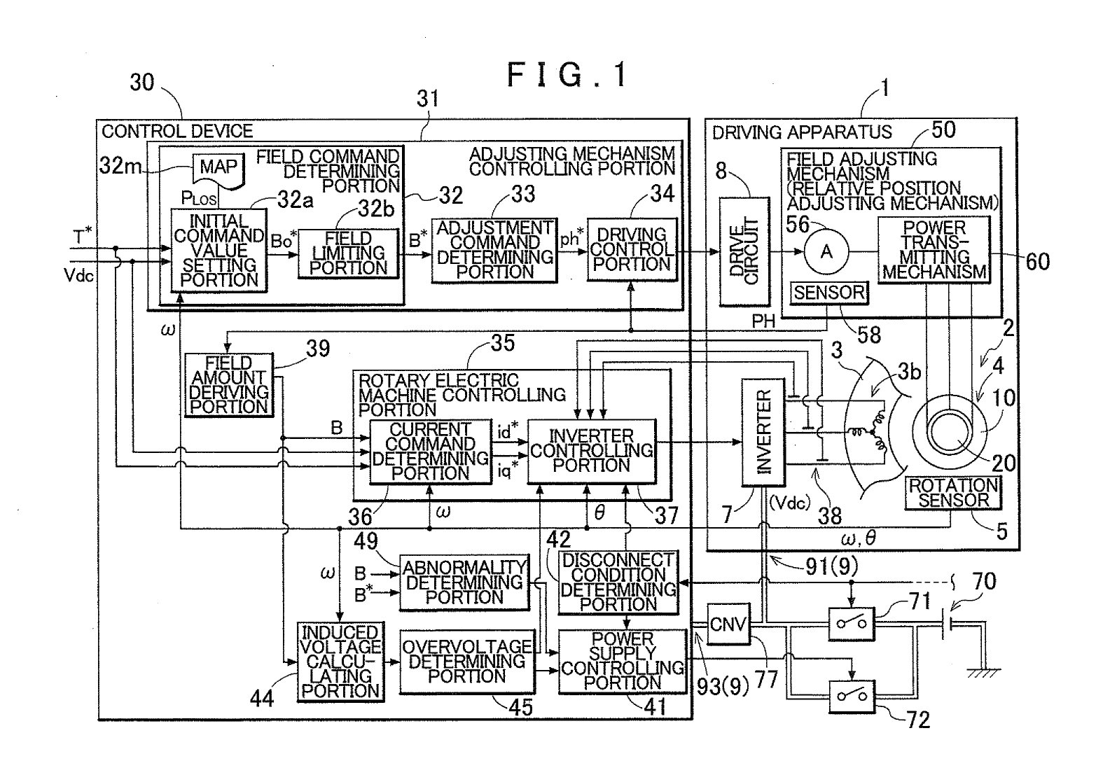

Hereinafter, an example in which a preferred example embodiment of the present invention is applied to a control device of a driving apparatus that is mounted in a vehicle, for example, and provides driving force to that vehicle will be described with reference to the drawings. FIG. 1 is a view showing a frame format of the overall structure of a driving apparatus 1 and a control device 30 of the driving apparatus according to the present invention. As shown in FIG. 1, the driving apparatus 1 includes a rotary electric machine 2 and a field adjusting mechanism 50, an inverter 7 that drives the rotary electric machine 2, and a drive circuit 8 that drives the field adjusting mechanism 50. The rotary electric machine 2 includes a rotor 4 that has permanent magnets, and a stator 3 that has a coil (i.e., a stator coil) 3b. The rotor 4 is configured to change a field flux that links to the coil 3b that generates a rotating magnetic field according to the relative positions, in the circumferential direction, of a first rotor 20 that is an inner rotor and a second rotor 10 that is an outer rotor. That is, the rotary electric machine 2 is a variable magnetic flux-type rotary electric machine. The field adjusting mechanism 50 is configured as a relative position adjusting mechanism that changes the relative positions of the first rotor 20 and the second rotor 10. This relative position adjusting mechanism (i.e., the field adjusting mechanism) 50 includes an actuator 56 that serves as a driving source that supplies driving power for changing the relative positions of the rotors 10 and 20, and a power transmitting mechanism 60 that transmits this driving force to the rotors 10 and 20. The actuator 56 is a motor, for example, and is feedback controlled based on an operation amount (such as the rotation speed or the rotation amount) of the motor that is detected by a sensor 58. The control device 30 controls the rotary electric machine 2 and the field adjusting mechanism 50 via the inverter 7 and the drive circuit 8. That is, the control device 30 performs optimization control that safely controls the driving apparatus 1 that includes the field adjusting mechanism 50 and the rotary electric machine 2 with high efficiency by decreasing the loss of the driving apparatus 1 as much as possible.

In this example embodiment, in order to the realize highly efficient and safe optimization control, the control device 30 includes, as core functional portions, an adjusting mechanism controlling portion 31 that controls the field adjusting mechanism 50, a rotary electric machine controlling portion 35 that controls the rotary electric machine 2, and a power supply controlling portion 41 that controls the supply of power to the driving apparatus 1 and the control device 30. The adjusting mechanism controlling portion 31 includes a field command determining portion 32, an adjustment command determining portion 33, and a driving control portion 34. The field command determining portion 32 is a functional portion that determines a field command value B* that serves as a target for the field flux that is adjusted by the field adjusting mechanism 50. The adjustment command determining portion 33 is a functional portion that determines an adjustment command ph* for driving the field adjusting mechanism 50 based on the field command value B*. The driving control portion 34 is a functional portion that drivingly controls the field adjusting mechanism 50 via the drive circuit 8 based on the adjustment command ph*. The detection result from the sensor 58 that detects an operation amount (an adjustment amount) PH or the like of the actuator 56 of the field adjusting mechanism 50 is input to the driving control portion 34. The driving control portion 34 performs feedback control based on this detection result. A characteristic of the control device 30 of the present invention is the power supply control by the power supply controlling portion 41. First, this power supply control will be described.

Power is supplied from a high voltage main power supply 70 of approximately 200 V, for example, to the driving apparatus 1 and the control device 30 via an ignition switch that serves as a main switch 71. High voltage direct current power is supplied to the inverter 7 in particular of the driving apparatus 1 via the main switch 71 and a power supply input portion 91 (9). When the rotary electric machine 2 functions as a regenerative source, electric power is regenerated to the main power supply 70 by the reverse path. The control device 30 is structured with a core of an electronic circuit such as a microcomputer or the like, and operates with a power supply voltage of 12 V or 24 V, for example, that is a lower voltage than the voltage of the main power supply 70. Depending on the circuit, the control device 30 operates with a power supply voltage of approximately 3.3 V to 5 V that has been further stepped down using a voltage regulator or the like. Therefore, the control device 30 is connected to the main power supply 70 via a converter 77 such as a DC-DC converter that converts the power supply voltage of the main power supply 70. That is, the control device 30 is connected to the main power supply 70 via the main switch 71, the converter 77, and a power supply input portion 93 (9). Although the power supply for the relative position adjusting mechanism 50 and the drive circuit 8 is not shown in FIG. 1, the relative position adjusting mechanism 50 and the drive circuit 8 preferably operate with a low power supply voltage that has been converted by the converter 77.

The main switch 71 is structured using a relay, for example, and is opened and closed in response to an open/close command signal generated by the operation of the ignition switch by a driver, or a command from an ECU (electronic control unit), not shown, that controls the overall vehicle. In this example embodiment, it is determined that a connect condition of the main power supply 70 is satisfied when the open/close command signal dictates a closed state (i.e., an on state). Also, it is determined that a disconnect condition of the main power supply 70 is satisfied when the open/close command signal dictates an open state (i.e., an off state). The control device 30 includes a disconnect condition determining portion 42 that determines whether the disconnect condition of the main power supply 70 is satisfied based on this open/close command signal, for example.

The driving apparatus 1 that includes the rotary electric machine 2 improves efficiency by reducing the system loss that includes iron loss and copper loss and the like, by changing the field flux of the rotary electric machine 2. Typically, a strong field flux is required when the driving apparatus 1 operates at low speed and high output (high torque), and a weak field flux is required in order to suppress back electromotive force (induced voltage) that accompanies a high speed of the rotor 4 at high speed and low output. However, when seeking efficiency, there are cases in which a strong field flux is necessary even when operating at high speed. Also, a variable magnetic flux mechanism may fail and become fixed with a strong field flux. In such a case, field-weakening control that supplies a weakened field current to the coil 3b may be executed while the field flux is strong. In this way, if an unexpected event occurs such that the disconnect condition of the main power supply 70 is satisfied during operation at high speed with a strong field flux, the control device 30, including the inverter 7, will also stop. The rotor 4 will continue to rotate from inertia, so induced voltage that has been induced in the coil 3b will be applied to the inverter 7. In this way, when the rotor 4 rotates at a high speed within a strong field flux, induced voltage that exceeds the voltage resistance of the direct current side of the inverter 7 may be generated. Therefore, the power supply controlling portion 41 that controls the connection and disconnection of the power supply input portion 9 with respect to the main power supply 70 is provided in the control device 30, and this power supply controlling portion 41 is controlled to keep the induced voltage within the voltage resistance limit of the inverter by operating the control device 30, including the inverter 7, intermittently.

More specifically, if it is determined that an overvoltage state exists when the disconnect condition is satisfied, the power supply controlling portion 41 keeps the main power supply 70 connected to the power supply input portion 9 regardless of the disconnect condition, at least until the overvoltage state is eliminated. Then, the rotary electric machine controlling portion 35 controls the rotary electric machine 2 according to field-weakening control that supplies a weakened field current that weakens the field flux to the coil 3b. The power supply controlling portion 41 disconnects the main power supply 70 according to the disconnect condition after the overvoltage state has been eliminated. Note that, the overvoltage state refers to a state in which the induced voltage exceeds the voltage resistance of the inverter 7. Also, this overvoltage state is determined by an overvoltage determining portion 45 that determines whether an overvoltage state, in which the induced voltage exceeds the voltage resistance of the inverter 7, exists. Further, the induced voltage is obtained by an induced voltage calculating portion 44 that calculates an induced voltage that is induced in the coil 3b, based on the rotation speed co of the rotor 4 and the estimated field amount B. At this time, if field-weakening control is being performed on the rotary electric machine 2, the induced voltage that actually appears will be lower than this calculation result. Therefore, even if it is determined by the overvoltage determining portion 45 that the overvoltage state exists based on the calculated induced voltage, the induced voltage may not be exceeding the voltage resistance of the inverter 7. Note that, the driving apparatus 1 includes the variable magnetic field-type rotary electric machine 2 in which the field flux can be adjusted, so the field flux is not constant. Instead, the estimated field amount B that is an estimated value of the field flux supplied from the rotor 4 to the stator 3 is obtained by a field amount deriving portion 39.

Though they do not prevent the power supply controlling portion 41 from controlling the main switch 71 open and closed, when the driving apparatus 1 and the control device 30 are one of the vehicle running systems, it may not be preferable for the power supply controlling portion 41 of the control device 30 that is one functional portion to directly control the connection state with the main power supply 70 for the entire vehicle. Therefore, in this example embodiment, a bypass is provided to enable the connection state with the main power supply 70 to be indirectly controlled. As shown in FIG. 1, a sub switch 72 that is separate from the main switch 71 that connects the power supply input portion 9 to the main power supply 70 when closed and disconnects the power supply input portion 9 from the main power supply 70 when open is provided. The sub switch 72 is provided bypassing the main switch 71, and enables the power supply input portion 9 to be connected to the main power supply 70 when closed, regardless of the open/closed state of the main switch 71. When it is determined that the overvoltage state exists, the power supply controlling portion 41 is able to keep the power supply input portion 9 connected to the main power supply 70, even if the main switch 71 suddenly opens due to an unexpected event, by controlling the sub switch 72 closed regardless of the disconnect condition.

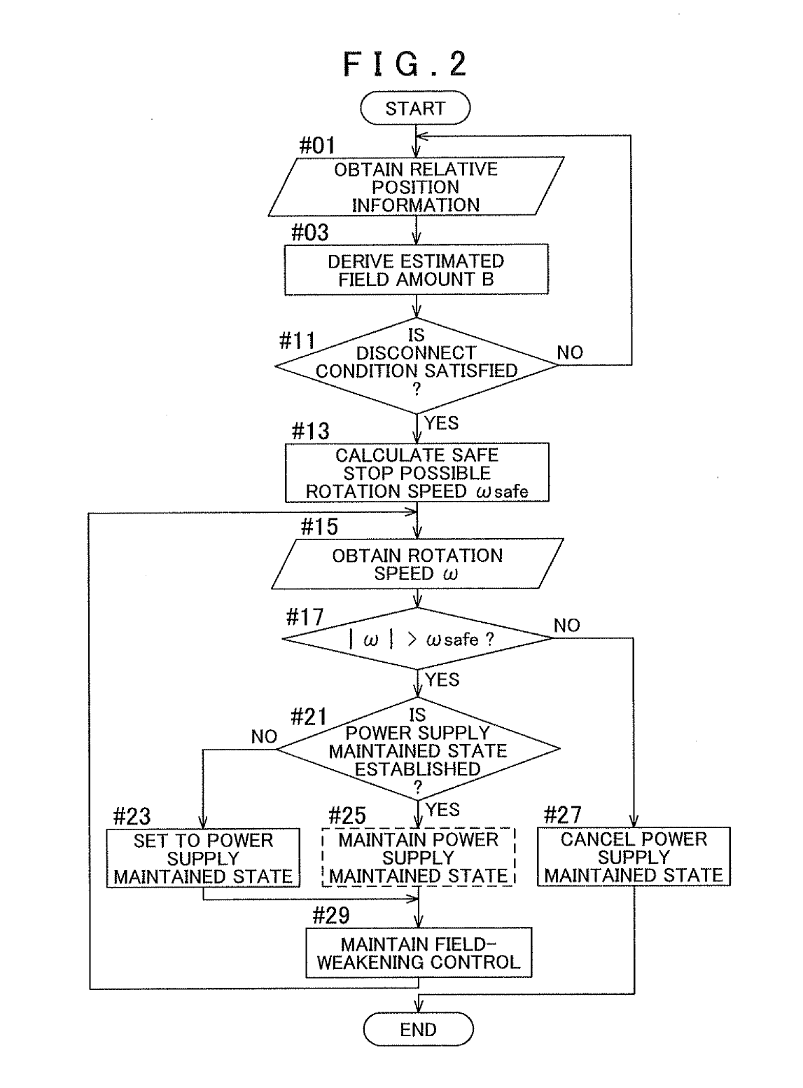

FIG. 2 is a flowchart illustrating one example of such power supply control by the control device 30. As one example, the control device 30 (i.e., the field amount deriving portion 39) obtains relative position information indicative of the relative positions of the rotors 10 and 20 from the sensor 58 of the field adjusting mechanism (relative position adjusting mechanism) 50 (#01), and derives the estimated field amount (the estimated magnetic flux density) B (#03). Alternatively, the control device 30 (i.e., the field amount deriving portion 39) may derive the estimated field amount B taking into account control delay and control error, based on a control command (a field command value B* that will be described later) that controls the field adjusting mechanism 50. Next, the control device 30 (the disconnect condition determining portion 42) determines whether the disconnect condition is satisfied (#11). If the disconnect condition is not satisfied, the control device 30 (disconnect condition determining portion 42) repeats steps #01 and #03 and obtains the latest estimated field amount B, and again makes a determination as to whether the disconnect condition is satisfied. Note that, step 411 is not limited to being this kind of determining step. It may also be an interrupt process.

If it is determined in step #11 that the disconnect condition is satisfied, a safe stop possible rotation speed ω_{safe}, is calculated based on the estimated field amount B (#13). Although it will be described later, this safe stop possible rotation speed ω_{safe} is a rotation speed of the rotor 4 that is a limit at which the induced voltage that is induced by the rotor 4 rotating within the estimated field flux will not exceed the voltage resistance of the inverter 7. After calculating the safe stop possible rotation speed ω_{safe}, the rotation speed ω of the rotor 4 is obtained by a rotation sensor 5 (#15), and a rotation speed of the rotor 4 irrespective of the rotational direction (that is, an absolute value |ω|) is compared with the safe stop possible rotation speed ω_{safe} (#17). If the absolute value |ω| of the rotation speed is exceeding the safe stop possible rotation speed ω_{safe}, the control device 30 determines that power supply needs to be maintained by the power supply controlling portion 41 (#17 Yes).

This determination is made mainly by the induced voltage calculating portion 44 and the overvoltage determining portion 45. That is, the safe stop possible rotation speed ω_{safe} is the rotation speed ω of the rotor 4 that is allowed at the estimated field amount B, and is thus back calculated from the allowable value of the induced voltage, i.e., from the voltage resistance of the inverter 7. The induced voltage is obtained from the absolute value |ω| of the rotation speed and the estimated field amount B, so comparing the absolute value |ω| of the rotation speed and the safe stop possible rotation speed ω_{safe} is equivalent to comparing the induced voltage and the voltage resistance of the inverter 7. Determinations by different approaches are illustrated with the hardware-type block structure in FIG. 1 and the software-type process flow in FIG. 2, but anyone skilled in the art can easily understand that these are essentially the same.

Here, the description will be continued returning to the flowchart in FIG. 2. If it is determined in step #17 that power supply needs to be maintained, the control device 30 (the power supply controlling portion 41) checks whether a power supply maintained state is currently established (#21). If a power supply maintained state is not established, the main power supply 70 and the power supply input portion 9 are set to the power supply maintained state (#23). In this example embodiment, it is assumed that the main power supply 70 and the power supply input portion 9 are connected bypassing the main switch 71, by controlling the sub switch 72 that is formed by a relay or the like closed. If the power supply maintained state is already established at the time of step #17, this power supply maintained state is maintained (#25). As one preferable embodiment, an open/close command signal that can give a command for a closed state (i.e., an on state) and a command for an open state (i.e., an off state) depending on, for example, a difference in signal level, such as high/low, is input from the control device 30 to a control terminal of the sub switch 72 formed by a relay or the like. The setting to the power supply maintained state in step #23 indicates a change in the open/close command signal from an open command to a close command. Maintaining the power supply maintained state in step #25 indicates that the open/close command signal is maintained as a close command. However, the open/close command signal that is a close command may be set again to a close command. Therefore, as shown by the broken line in FIG. 2, step #25 does not need to be provided separately. It is possible to provide only step #23.

If it is determined in step #17 that power supply does not need to be maintained, the control device 30 (the power supply controlling portion 41) cancels the power supply maintained state between the main power supply 70 and the power supply input portion 9 (#27). Just as with the setting of the power supply maintained state, this cancelation includes both a change to cancellation from the power supply maintained state and the maintaining of a canceled state.

When it is determined in step #17 that power supply needs to be maintained, the overvoltage state exists and the field flux is strong with respect to the rotation speed ω. In order to eliminate this state by electrical control, the control device 30 (the rotary electric machine controlling portion 35) controls the rotary electric machine 2 according to field-weakening control (#29). As described above, in such a situation, the rotary electric machine controlling portion 35 may already be executing field-weakening control, in which case the field-weakening control is maintained. The equivalence of starting and maintaining field-weakening control is synonymous with that described in the setting, canceling, and maintaining of the power supply maintained state, so a detailed description thereof will be omitted.

When it is determined in step #17 that power supply needs to be maintained, i.e., when the overvoltage state exists, the connection with the main power supply 70 is established and field-weakening control is executed, as described above. The control device 30 repeatedly executes steps #15 and #17 and checks whether the overvoltage state has been eliminated. When the overvoltage state is eliminated, the determination in step #17 will be No, so the power supply maintained state is canceled (#27), and the entire routine ends. If the main switch 71 is open according to the disconnect condition that is already satisfied, the main power supply 70 is disconnected from the power supply input portion 9 by the sub switch 72 being changed to an open state in response to the cancellation of the power supply maintained state. When the power supply controlling portion 41 is structured to be able to directly control the main switch 71, the main power supply 70 is disconnected from the power supply input portion 9 by the main switch 71 changing to an open state according to the disconnect condition that is already satisfied.

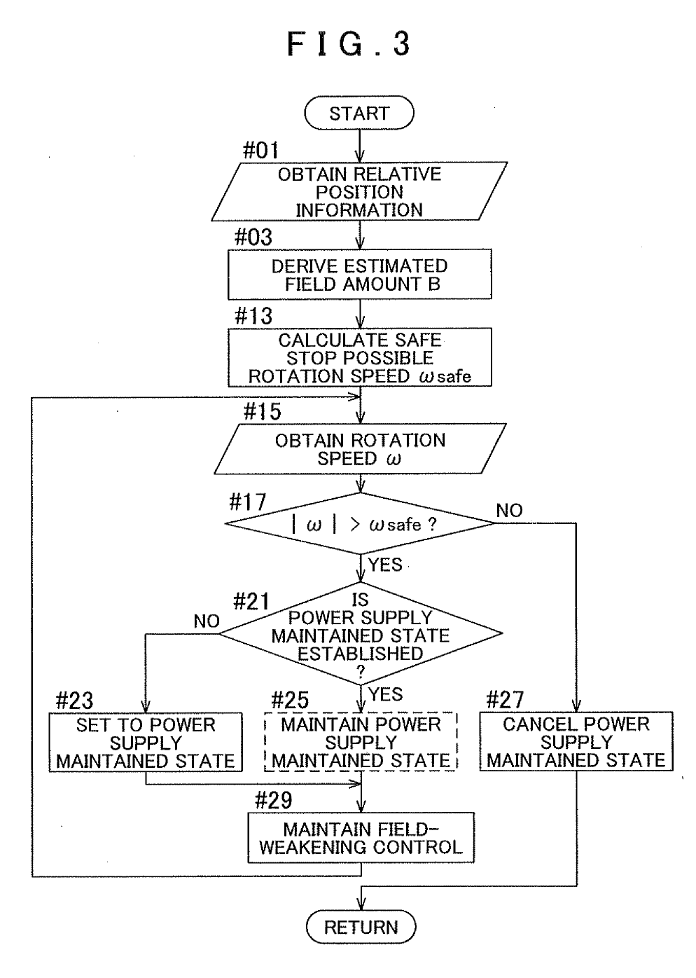

As described above, in this example embodiment, the sub switch 72 that is provided separate from the main switch 71 and bypassing the main switch 71, and that is able to connect the power supply input portion 9 to the main power supply 70 when closed regardless of the open/closed state of the main switch 71, is provided. When it is determined that the overvoltage state exists, the power supply controlling portion 41 is able to maintain the connection between the power supply input portion 9 and the main power supply 70, even if the main switch 71 suddenly opens due to an unexpected event, by controlling the sub switch 72 closed regardless of the disconnect condition. As one preferable embodiment, a subroutine that secures the power supply maintained state by controlling the sub switch 72 closed when it is determined that the overvoltage state exists without taking into account whether the disconnect condition is satisfied may be executed, as shown in the flowchart in FIG. 3. This subroutine is not conditional upon the disconnect condition being satisfied, so it may be repeatedly executed while the main power supply 70 and the power supply input portion 9 are connected. Even if the main switch 71 suddenly opens due to an unexpected event, the connection between the main power supply 70 and the power supply input portion 9 is already ensured via the sub switch 72, so the main power supply 70 can ultimately be disconnected from the power supply input portion 9 by safely controlling the rotary electric machine 2. Note that, the details of the steps denoted by like reference numerals in FIGS. 2 and 3 are the same, so a detailed description thereof will be omitted.

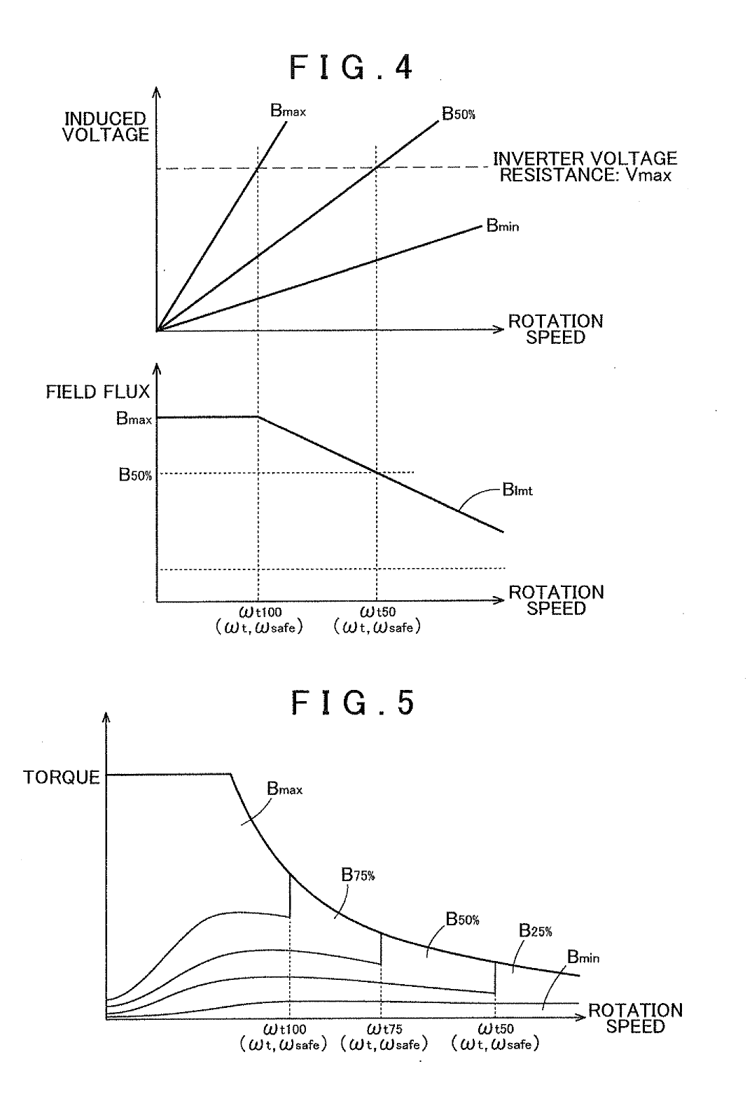

Also, as one preferred embodiment, this kind of control device 30 of the driving apparatus 1 may adjust the field flux by the field adjusting mechanism 50 based on at least the rotation speed ω, with a field limiting value set according to the rotation speed of the rotor 4 within a range in which the induced voltage will not exceed the voltage resistance of the inverter 7 as the upper limit. That is, the adjusting mechanism controlling portion 31 preferably determines a field command value that serves as a target for the field flux under such a condition, and controls the field adjusting mechanism 50. This kind of field limiting value may be taken as a concept similar to the safe stop possible rotation speed ω_{safe} described above. Hereinafter, the field limiting value and the safe stop possible rotation speed ω_{safe} will be described with reference to FIGS. 4 and 5.

When the rotor 4 that provides the field flux that links to the coil 3b rotates, induced electromotive force is generated in the coil 3b. This induced electromotive force is rectified by the inverter 7, and as a result, direct current induced voltage appears on the direct current power supply side of the inverter 7. If the field flux is constant, this induced voltage is proportional to the rotation speed ω. The graph in the upper part of FIG. 4 shows a frame format of the relationship between the direct current induced voltage and the rotation speed when the magnetic flux density of the field flux is Bₘₐₓ that is a maximum value with the structure of the rotor 4, when the magnetic flux density of the field flux is B_{50%} that is 50% of the maximum value Bₘₐₓ, and when the magnetic flux density of the field flux is Bₘᵢₙ that is a minimum value with the structure of the rotor 4. Here, it is assumed that FIG. 4 is a graph that includes the maximum rotation speed of the rotor 4. When the magnetic flux density of the field flux is the minimum value Bₘᵢₙ, the induced voltage will not exceed the voltage resistance Vₘₐₓ of the inverter 7 even if the rotor 4 reaches the maximum rotation speed. On the other hand, when the magnetic flux density is Bₘₐₓ and B_{50%}, the induced voltage will reach the voltage resistance Vₘₐₓ of the inverter 7 at a speed limit ωₜ of a rotation speed ωₜ₁₀₀ and ωₜ₅₀, respectively.

If the induced voltage exceeds the voltage resistance Vₘₐₓ of the inverter 7, it may damage the inverter 7. Therefore, a field limiting value Bₗₘₜ that serves as an upper limit is set according to the rotation speed ω of the rotor 4, as shown in the graph in the lower part of FIG. 4. That is, a field limiting value Bₗₘₜ that is a value that decreases as the rotation speed ω increases is set. The field command determining portion 32 determines the field command value B* based on at least the rotation speed ω of the rotor 4, with the field limiting value Bₗₘₜ, that is set according to the rotation speed ω of the rotor 4 within a range in which the induced voltage will not exceed the voltage resistance Vₘₐₓ of the inverter 7, as the upper limit.

The output (torque) of the rotary electric machine 2 is typically controlled based on a target torque (i.e., a torque command) T* and the rotation speed ω. Therefore, preferably the field command determining portion 32 may determine the field command value B* based on at least the target torque T* and the rotation speed ω, with the field limiting value Bₗₘₜ as the upper limit. FIG. 5 is a torque map of the control region of each field flux provided with a field limit. Here, B_{75%} indicates a magnetic flux density that is 75% of the maximum value Bₘₐₓ, and B_{25%} indicates a magnetic flux density that is 25% of the maximum value Bₘₐₓ. In this torque map, a limit is applied at the speed limit ωₜ (i.e., ωₜ₁₀₀, ωₜ₇₅, and ωₜ₅₀) as described above to the field fluxes having magnetic flux densities of Bₘₐₓ, B_{75%}, and B_{50%}. In each of the control regions with a rotation speed ω higher than the speed limit ωₜ, the field fluxes are unable to be set. With the field fluxes having magnetic flux densities of B_{25%} and Bₘᵢₙ, the speed limit ωₜ is not set because the induced voltage will not exceed the voltage resistance Vₘₐₓ even if the rotor 4 reaches the maximum rotation speed. Therefore, the field fluxes B_{25%} and Bₘᵢₙ can be set in all of the control regions corresponding to the target torque T*, irrespective of the rotation speed ω. As one example, the field command determining portion 32 may determine the field command value B* referencing this kind of torque map. FIG. 5 shows the speed limits ωₜ corresponding to stepped field fluxes, but in actuality, a map that defines the speed limits ωₜ corresponding to continuous or smaller subdivided stepped field fluxes is preferably used. The field limiting value Bₗₘₜ that is the limiting value for the determination of this kind of field command value B* is closely related to the speed limit ωₜ. Also, the field flux of the upper limit for the induced voltage similarly becomes the field limiting value Bₗₘₜ, so the speed limit ωₜ corresponds to the safe stop possible rotation speed ω_{safe}.

The field command determining portion 32 preferably determines the field command value B* for appropriately controlling the field adjusting mechanism 50, as one functional portion of the control device 30 that optimally controls the driving apparatus 1 safely and with high efficiency by reducing the loss of the driving apparatus 1 as much as possible. In order to control the driving apparatus 1 with high efficiency by reducing loss, the field command determining portion 32 preferably determines the field command value B* based on at least the rotation speed ω, the target torque T*, and system loss P_{LOS} of the driving apparatus 1 that includes iron loss and copper loss that change according to the rotation speed ω and the target torque T* of the rotary electric machine 2. At this time, in order to safely control the driving apparatus 1, the field command determining portion 32 determines the field command value B*, with the field limiting value Bₗₘₜ as the upper limit. Note that, the optimum field flux may be different depending also on the direct current voltage Vdc of the inverter 7, so the field command determining portion 32 preferably determines the field command value B* also referencing the direct current voltage Vdc, as shown in FIG. 1.

In order to determine the field command value B* as described above, the field command determining portion 32 preferably includes an initial command value setting portion 32a and a field limiting portion 32b, as shown in FIG. 1. The initial command value setting portion 32a is a functional portion that sets an initial field command value B₀*. The field limiting portion 32b is a functional portion that applies a limit in which the field limiting value Bₗₘₜ is the upper limit to the initial field command value B₀*, and then determines the field command value B*. The initial command value setting portion 32a sets the field flux at which the system loss P_{LOS} of the driving apparatus 1 that includes iron loss and copper loss is minimal as the initial field command value B₀* based on at least the target torque T* and the rotation speed ω. In this example embodiment, the initial field command value B₀* is set also taking the direct current voltage Vdc into account.

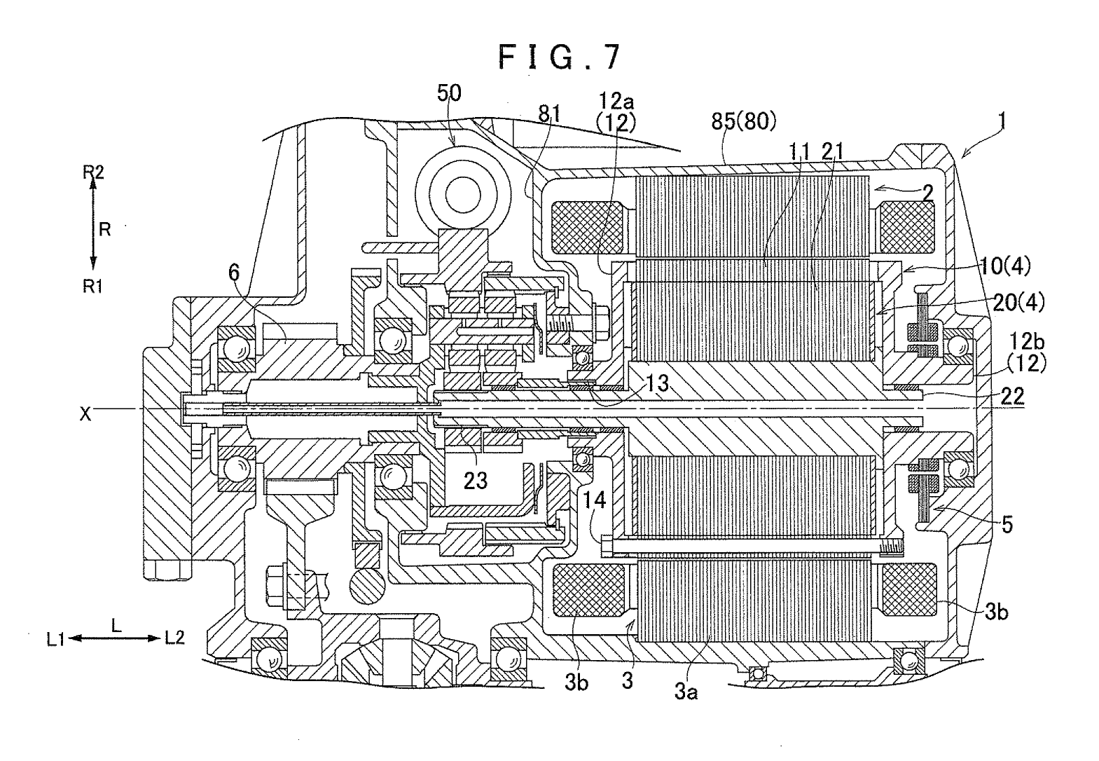

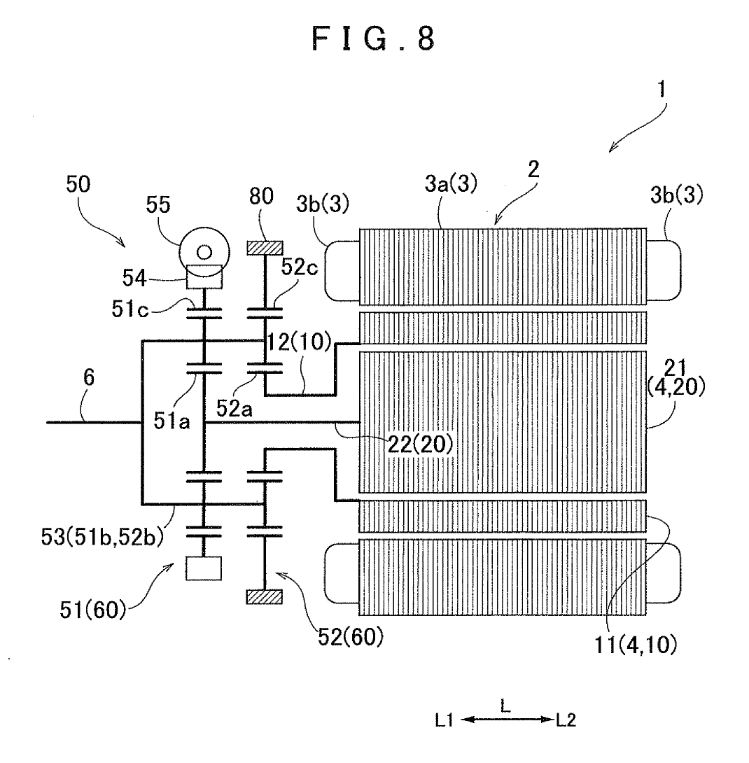

The system loss P_{LOS} preferably includes electrical loss that includes copper loss and iron loss of the rotary electric machine 2, and mechanical loss of the field adjusting mechanism 50 configured as a relative position adjusting mechanism. The detailed structure of the relative position adjusting mechanism 50 will be described later, but mechanical loss is loss represented by gear loss of the relative position adjusting mechanism that includes a differential gear mechanism as the power transmitting mechanism 60. Also, electrical loss may include, in addition to copper loss and iron loss, inverter loss that is switching loss mainly in a switching element of the inverter 7. Iron loss is electric energy that is lost when magnetic flux that passes through a stator core 3a (see FIGS. 7 and 8) and rotor cores 11 and 21 (see FIGS. 7 and 8) changes due to the magnetic field generated by the coil 3b and the permanent magnets, such as hysteresis loss and eddy current loss or the like. Copper loss is electric energy that is lost by being turned into Joule heat as a result of the resistance of the conducting wire of the coil 3b. Note that, the system loss P_{LOS} may also include other various types of loss in the driving apparatus 1, in addition to the examples described here.

With electrical loss and mechanical loss that make up the system loss P_{LOS}, there is often no correlation that can be easily generalized by a function or the like. Therefore, as shown in FIG. 1, the system loss P_{LOS} is preferably prepared in advance as a map 32m. This map 32m may be created by performing data analysis and data optimization based on loss data obtained through testing or magnetic field analysis simulation or the like, for each rotation speed ω and torque of the rotary electric machine 2 (i.e., the driving apparatus 1). In this example embodiment, in this map 32m, the relationship between the target torque T* and the rotation speed ω of the driving apparatus 1 (or the rotary electric machine 2) and the relative positions of the rotors 10 and 20 that realize the field flux at which the system loss P_{LOS} is minimal is defined. The initial command value setting portion 32a sets the field flux at which the system loss P_{LOS} is minimal as the initial field command value B₀*, based on at least the target torque T* and the rotation speed ω referencing the map 32m. Also, the field limiting portion 32b applies a limit in which the field limiting value Bₗₘₜ is the upper limit to the initial field command value B₀*, and then determines the field command value B*.

When this kind of adjusting mechanism controlling portion 31 is provided, it is possible to adjust the field flux so that the induced voltage will not exceed the voltage resistance Vₘₐₓ of the inverter 7, even if the disconnect condition of the main power supply 70 (the main switch 71) is satisfied as a result of an unexpected event. That is, having the adjusting mechanism controlling portion 31 apply a limit in which the field limit value Bₗₘₜ is the upper limit and determine the field command value B* effectively functions as a failsafe mechanism. However, if an abnormality occurs in the field adjusting mechanism 50 or the adjusting mechanism controlling portion 31, there is a possibility that this failsafe mechanism will not function sufficiently. As described above, in this example embodiment, the sub switch 72 that is separate from the main switch 71 and that is able to connect the main power supply 70 to the power supply input portion 9 bypassing the main switch 71, irrespective of the open/closed state of the main switch 71, is provided. When this kind of sub switch 72 is provided, it is possible to prepare for the disconnect condition to be suddenly satisfied, even when the failsafe mechanism does not function sufficiently, by closing the sub switch 72 before the disconnect condition is satisfied.

As one preferred embodiment, in this example embodiment, as shown in FIG. 1, the control device 30 includes an abnormality determining portion 49 that determines an abnormality of at least one of the rotary electric machine controlling portion 35 and the field adjusting mechanism 50. If the abnormality determining portion 49 determines that there is an abnormality, the power supply controlling portion 41 is able to control the sub switch 72 closed regardless of the disconnect condition. At this time, it is preferable to set an additional condition that it be determined that an overvoltage state exists, such that when the power supply controlling portion 41 controls the sub switch 72 closed, it will not close the sub switch 72 unnecessarily. That is, the power supply controlling portion 41 preferably controls the sub switch 72 closed regardless of the disconnect condition when it is determined that the overvoltage state exists and the abnormality determining portion 49 determines that there is an abnormality.

The abnormality determining portion 49 determines that there is an abnormality when, for example, the difference (the absolute value) between the field command value B* and the estimated field amount B that is derived by the field amount deriving portion 39 is greater than a predetermined allowable difference ΔBₜ. Here, the field amount deriving portion 39 is a functional portion that obtains the estimated field amount B that is an estimated value of the field flux supplied from the rotor 4 to the stator 3. As a preferred embodiment, in this example embodiment, the estimated field amount B is obtained based on a detection result (a detection result of the sensor 58) of the actual adjustment amount (relative position information) PH by the field adjusting mechanism 50 controlled based on the field command value B*. When the field adjusting mechanism 50 adjusts the field flux based on the field command value B*, a control delay (time lag) or error may occur. With respect to this, the detection result of the actual adjustment amount PH by the field adjusting mechanism 50 is indicated with the most recent state of the field adjusting mechanism 50 as the actual state, so the field amount deriving portion 39 is able to accurately estimate the most recent field amount.

If the difference between the field command value B* and the estimated field amount B is greater than the predetermined allowable difference ΔBₜ, the control delay or error is large, so the abnormality determining portion 49 determines that at least one of the adjusting mechanism controlling portion 31 and the field adjusting mechanism 50 is abnormal. That is, there is a possibility that the adjusting mechanism controlling portion 31 is unable to sufficiently control the field adjusting mechanism 50 or the field adjusting mechanism 50 is not operating due to a mechanical failure or the like, so it is determined that the adjustment of the field flux cannot be made appropriately. Here, an embodiment is illustrated in which an abnormality is determined according to whether the difference between the field command value B* and the estimated field amount B is greater than the predetermined allowable difference ΔBₜ, but the determining condition by the abnormality determining portion 49 is not limited to this embodiment. An abnormality in the actuator 56 may be detected by the sensor 58 provided in the actuator 56 of the field adjusting mechanism 50, or an abnormality in the actuator 56, the power transmitting mechanism 60, or the drive circuit 8 may be detected using another sensor.

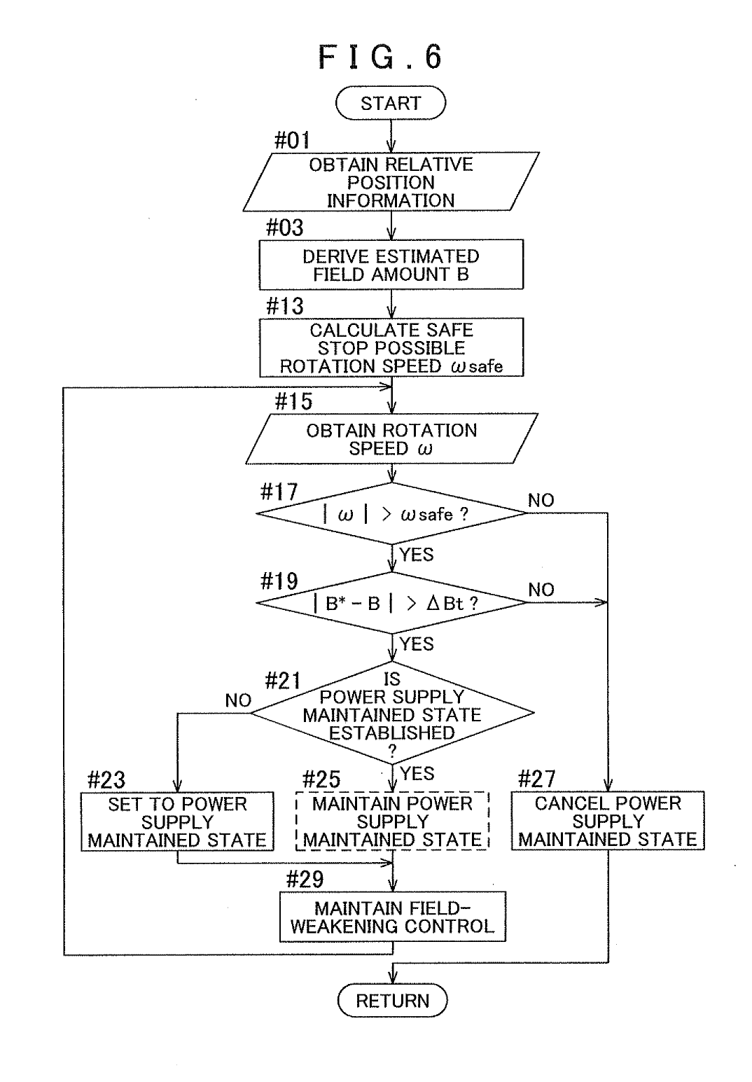

FIG. 6 is a view of a subroutine that includes an abnormality determining process (step #19) by that kind of abnormality determining portion 49. This subroutine is executed after step #17 that performs an overvoltage determination in the subroutine shown in FIG. 3. If the determination conditions in both step 17 and step 19 are satisfied, it is determined that the overvoltage state exists and it is determined that there is an abnormality, so the sub switch 72 is controlled closed and the power supply maintained state is established. The details of the steps, excluding step #19, is just as described above with reference to FIGS. 2 and 3, so detailed descriptions thereof will be omitted.

As described above, the rotary electric machine controlling portion 35 is provided as another core functional portion of the control device 30 in order to realize efficient and safe optimization control. In this example embodiment, the rotary electric machine controlling portion 35 detects the current flowing to the coil 3b using a current sensor 38, and controls the rotary electric machine 2 by performing control according to current feedback. Therefore, the rotary electric machine controlling portion 35 includes a current command determining portion 36 that determines a current command that serves as the target for the current that flows to the coil 3b, and an inverter controlling portion 37 that controls the inverter 7 based on this current command. In this example embodiment, the rotary electric machine controlling portion 35 controls the rotary electric machine 2 according to well-known vector control. With vector control, feedback control is performed by, for example, coordinate-transforming alternating current that flows to the coil 3b of each of three phases to a vector component of a d-axis that is the direction of the magnetic field generated by the permanent magnets arranged in the rotor 4 and a q-axis that is electrically orthogonal to the d-axis. Therefore, the current command determining portion 36 determines two current commands id* and iq* that correspond to the d-axis and the q-axis, respectively.

As an example, the current command determining portion 36 takes the d-axis current and the q-axis current on the respective axes on orthogonal coordinates, and determines the current commands id* and iq* referencing a constant torque map in which a plurality of constant torque lines where the d-axis current and the q-axis current when outputting the same torque are plotted are defined. A maximum torque control line at which the target torque T* is able to be output with maximum efficiency is set on the constant torque map so as to intersect the constant torque lines. Basically, the values of id and iq at the intersection of maximum torque control line and the constant torque lines corresponding to the target torque T* on the constant torque map become the current commands id* and iq*. Although not an aspect of the present invention so a detailed description will be omitted, the current command determining portion 36 determines the current commands id* and iq* by adding an additional control factor, such as field-weakening control or field-strengthening control that takes into account for example induced voltage that is induced in the coil 3b according to the rotation speed ω, to the values of id and iq obtained referencing the constant torque map.

A plurality of these constant torque maps are prepared for each magnetic flux density of the field flux. For example, with a constant torque map when the magnetic flux density of the field flux is Bₘₐₓ and a constant torque map when the magnetic flux density of the field flux is B_{50%}, the constant torque map when the magnetic flux density is B_{50%} in which the field flux is relative weak is set so that more current is required to output the same torque. As can be understood also from the torque map in FIG. 5, naturally when the field flux becomes weaker, there is also torque that cannot be defined on the constant torque map. As a preferred embodiment, the current command determining portion 36 determines the current commands id* and iq* referencing a constant torque map prepared in advance for each field flux. Accordingly, the current command determining portion 36 may determine the current commands id* and iq* based on at least the field flux and the target torque T*. As described above, to determine the current commands id* and iq*, it is desirable to also take into account the rotation speed ω that relates to the induced voltage that is induced in the coil 3b and the like, so the current command determining portion 36 preferably determines the current commands id* and iq* based on at least the field flux, the target torque T*, and the rotation speed ω. Also, in this example embodiment, the current commands id* and iq* may be determined also taking the direct current voltage Vdc into account, similar to the initial field command value B₀* and the field command value B* described above.

Here, the current command determining portion 36 may use the field command value B* as the value of the field flux. However, the actuator 56 is driven after determining the field command value B*, so there may be a control delay until the field adjusting mechanism 50 is driven and the field is actually adjusted. Further, there may also be error between the adjusted field flux and the field command value B*. Therefore, as described above, in this example embodiment, the actual operation amount PH of the actuator 56 is used as the actual adjustment amount by the field adjusting mechanism 50, and the field flux is estimated from this adjustment amount (i.e., the operation amount) PH. More specifically, the control device 30 includes the field amount deriving portion 39 that obtains an estimated field amount (i.e., an estimated magnetic flux density) B that is an estimated value of the actual field flux, based on the detection result of the actual adjustment amount PH by the field adjusting mechanism 50 controlled based on the field command value B*. The current command determining portion 36 determines the current commands id* and iq* using this estimated field amount B. That is, as one preferred embodiment, the current command determining portion 36 determines the current commands id* and iq* based on at least the estimated field amount B, the target torque T*, and the rotation speed ω.

The inverter controlling portion 37 performs proportional integral control (PI control) and proportional-integral-derivative control (PID control) based on the difference between the current commands id* and iq* and the current of the coil 3b that is detected by the current sensor 38 and fed back, and then calculates a voltage command. Then the inverter controlling portion 37 generates a control signal that drives a switching element such as an IGBT (insulated gate bipolar transistor) that forms the inverter 7 according to PWM (pulse width modulation) control or the like, based on this voltage command. At this time, the rotor position (field angle and electrical angle) 0 of the rotor 4 detected by a rotation sensor 5 is referenced in order to perform a coordinate transformation between the vector space of two phases of the vector control and the actual space of the inverter 7 of three phases.

Now, the field adjusting mechanism 50 adjusts the field flux by displacing at least a portion of the rotor 4 in the circumferential direction or the axial direction of the rotor 4, as described above. Then the field adjusting mechanism 50 includes the driving source (i.e., the actuator) 56 that supplies driving force for this displacement, and the power transmitting mechanism 60 that transmits the driving force from the actuator 56 to the rotor 4. In this example embodiment, the rotor 4 includes a first rotor 20 and a second rotor 10 (see FIGS. 1, 7, and 8) that have rotor cores 21 and 11, respectively. The relative positions of the first rotor 20 and the second rotor 10 can be adjusted. The rotor 4 also has permanent magnets in at least one of the rotor cores 11 and 21 inside the rotors 10 and 20. The field adjusting mechanism 50 is configured as a relative position adjusting mechanism that adjusts the field flux by displacing the relative positions of the rotors 10 and 20 in the circumferential direction.

In this example embodiment, the first rotor 20 and the second rotor 10 are both drivingly connected to a common output member. The relative position adjusting mechanism (i.e., the field adjusting mechanism) 50 includes, as the power transmitting mechanism 60, a first differential gear mechanism 51 and a second differential gear mechanism 52, that will be described below, that both have three rotating elements (see FIG. 8). As shown in FIG. 8, the first differential gear mechanism 51 includes, as the three rotating elements, a first rotor connecting element 51a that is drivingly connected to the first rotor 20, a first output connecting element 51b that is drivingly connected to the output member, and a first stationary element 51c. The second differential gear mechanism 52 includes, as the three rotating elements, a second rotor connecting element 52a that is drivingly connected to the second rotor 10, a second output connecting element 52b that is drivingly connected to the output member, and a second stationary element 52c. One of the first stationary element 51c and the second stationary element 52c serves as a displaceable stationary element that is operatively linked to the actuator 56, and the other serves as a non-displaceable stationary element that is fixedly linked to a non-rotating member. In the example in the drawing, the first stationary element 51c is serving as the displaceable stationary element, and the second stationary element 52c is serving as the non-displaceable stationary element. Also, the gear ratio of the first differential gear mechanism 51 and the gear ratio of the second differential gear mechanism 52 are set such that the rotation speed of the second rotor connecting element 52a and the rotation speed of the first rotor connecting element 51a while this displacement stationary element is held stationary are equal.

Hereinafter, a specific example of the driving apparatus 1 that realizes this kind of mechanism will be described with reference to FIGS. 7 and 8. As shown in FIG. 7, the rotary electric machine 2 is an inner rotor-type rotary electric machine that has two rotors, the relative positions of which can be changed. The rotor 4 includes the second rotor 10 that is an outer rotor that faces the stator 3, and the first rotor 20 that is an inner rotor. The first rotor 20 includes a first rotor core 21 and permanent magnets that are embedded in this first rotor core 21. The second rotor 10 includes a second rotor core 11 and a gap that serves as a flux barrier that is formed in the second rotor core 11. The field flux is adjusted by the magnetic circuit changing as the positional relationship between the permanent magnets and the flux barrier changes according to the relative positions of the first rotor 20 and the second rotor 10. The rotary electric machine 2 is housed in a case 80, and together with the relative position adjusting mechanism (i.e., the field adjusting mechanism) 50 that adjusts the relative positions in the circumferential direction of the first rotor 20 and the second rotor 10, fowls the driving apparatus 1. The driving apparatus 1 is able to transmit driving force (also referred to as torque) of the rotary electric machine 2 to a rotor shaft 6 that serves as an output shaft via the relative position adjusting mechanism 50.

In the description below, unless otherwise stated, the terms “axial direction L”, “radial direction R”, and “circumferential direction” are used based on the axis of the first rotor core 21 and the second rotor core 11 that are arranged on the same axis (i.e., rotational axis X). Also in the description below, the term “first axial L1” refers to the left in the axial direction L in FIG. 7, and the term “second axial L2” refers to the right in the axial direction L in FIG. 7. Also, the term “radially inner R1” refers to the direction toward the inside (i.e., the shaft center side) of in the radial direction R, and the term “radially outer R2” refers to the direction toward the outside (i.e., the stator side) in the radial direction R.

The stator 3 that forms the armature of the rotary electric machine 2 includes the stator core 3a and the coil (i.e., the stator coil) 3b that is wound around the stator core 3a, and is fixed to the inside surface of a peripheral wall portion 85 of the case 80. The stator core 3a is formed in a circular cylindrical shape by stacking a plurality of magnetic steel sheets together. The rotor 4 as the field that has the permanent magnets is arranged on the radially inner R1 side of the stator 3. The rotor 4 is supported by the case 80 in a manner rotatable about the rotational axis X, and rotates relative to the stator 3.

The first rotor 20 and the second rotor 10 that form the rotor 4 include the first rotor core 21 and the second rotor core 11, respectively. The first rotor core 21 and the second rotor core 11 are arranged on the same axis so as to overlap when viewed from the radial direction R. In this example embodiment, the first rotor core 21 and the second rotor core 11 have the same length in the axial direction L, and are arranged so as to completely overlap when viewed from the radial direction R. The first rotor core 21 and the second rotor core 11 are formed by stacking a plurality of magnetic steel sheets together, just like the stator core 3a. The first rotor 20 is formed with permanent magnets embedded in the first rotor core 21 that provide the field flux that links to the coil 3b. A gap that serves as a flux barrier is formed in the second rotor core 11. The permanent magnets and the flux barrier are arranged such that the field flux that reaches the stator 3 changes according to the relative positions in the circumferential direction of the first rotor 20 and the second rotor 10. For example, the permanent magnets and the flux barrier may be arranged such that, depending on the relative positions of the rotors 10 and 20, one of two states is established, one being a state in which a magnetic circuit that serves as a bypass is formed in the second rotor core 11 such that leakage flux increases so that less magnetic flux that reaches the stator 3, and the other being a state in which leakage flux that passes through the second rotor core 11 is suppressed so that more magnetic flux reaches the stator 3.

The first rotor 20 includes a first rotor core supporting member 22 that supports the first rotor core 21 and that rotates together with the first rotor core 21. This first rotor core supporting member 22 is configured to contactingly support the first rotor core 21 from the radially inner R1 side. Also, the first rotor core supporting member 22 is rotatably supported with respect to a second rotor core supporting member 12 by a bearing (a bush in this example) that is arranged on the first axial L1 side of the first rotor core 21, and a bearing (a bush in this example) that is arranged on the second axial L2 side of the first rotor core 21. Also, first spline teeth 23 that spline engage with a rotating element (i.e., a first sun gear 51a that serves as the first rotor connecting element) of the relative position adjusting mechanism 50 are formed on an outer peripheral surface of the first axial L1 side portion of the first rotor core supporting member 22.

The second rotor 10 includes a second rotor core supporting member 12 that supports the second rotor core 11 and that rotates together with the second rotor core 11. This second rotor core supporting member 12 includes a first supporting portion 12a that supports the second rotor core 11 from the first axial L1 side, and a second supporting portion 12b that supports the second rotor core 11 from the second axial L2 side. The first supporting portion 12a and the second supporting portion 12b are fastened and fixed in the axial direction L by a fastening bolt 14 that is inserted through an insertion hole formed in the second rotor core 11. That is, the second rotor core 11 is fixed and held by being sandwiched between the first supporting portion 12a and the second supporting portion 12b.

The first supporting portion 12a is supported in the radial direction R by a bearing (a roller bearing in this example) that is arranged on the first axial L1 side of the second rotor core 11, and the second supporting portion 12b is supported in the radial direction R by a bearing (a roller bearing in this example) that is arranged on the second axial L2 side of the second rotor core 11. Also, second spline teeth 13 that spline engage with a rotating element (a second sun gear 52a in this example) of the relative position adjusting mechanism 50 are formed on an inner peripheral surface of a first axial L1 side portion of the first supporting portion 12a. Also, a sensor rotor of the rotation sensor 5 (a resolver in this example embodiment) is attached to an outer peripheral surface of the second axial L2 side of the second supporting portion 12b so as to rotate together with the second supporting portion 12b. The rotation sensor 5 detects a rotational position (electrical angle θ) and the rotation speed ω of the rotor 4 with respect to the stator 3.

The rotor shaft 6 is an output shaft that outputs the driving force of the driving apparatus 1. The rotor shaft 6 is arranged on the same axis as the first rotor core 21 and the second rotor core 11, and is drivingly connected to a rotating element of the relative position adjusting mechanism 50 (i.e., a first carrier 51b that serves as the first output connecting element 51b and a second carrier 52b that serves as the second output connecting element 52b), similar to the first rotor core 21 and the second rotor core 11. The first rotor core 21 and the second rotor core 11 rotate at the same speed as each other (i.e., the rotor rotation speed) except for when the rotative position in the circumferential direction is adjusted. In this example embodiment, the rotation speed of the rotor shaft 6 is reduced with respect to the rotation speed of the rotor 4 by the differential gear mechanisms 51 and 52, and the torque of the rotary electric machine 2 is multiplied and transmitted to the rotor shaft 6.

The relative position adjusting mechanism 50 that has the first differential gear mechanism 51 and the second differential gear mechanism 52 that both have three rotating elements is arranged on the first axial L1 side of the rotary electric machine 2. Also, the two differential gear mechanisms 51 and 52 as the power transmitting mechanism 60 are arranged lined up in the axial direction L such that the first differential gear mechanism 51 is positioned on the first axial L1 side of the second differential gear mechanism 52. The relative position adjusting mechanism 50 adjusts the relative positions in the circumferential direction of the first rotor core 21 that rotates together with the first rotor core supporting member 22, and the second rotor core 11 that rotates together with the second rotor core supporting member 12, by adjusting the relative positions in the circumferential direction of the first rotor core supporting member 22 that is drivingly connected to the first differential gear mechanism 51, and the second rotor core supporting member 12 that is drivingly connected to the second differential gear mechanism 52.

In this example embodiment, the first differential gear mechanism 51 and the second differential gear mechanism 52 are formed both by a single pinion planetary gear set that has three rotating elements. The first differential gear mechanism 51 includes, as the three rotating elements, a first sun gear (i.e., the first rotor connecting element) 51a that is drivingly connected to the first rotor 20, a first carrier (i.e., the first output connecting element) 51b that is drivingly connected to the rotor shaft 6, and a first ring gear (i.e., the first stationary element) 51c. Both the first sun gear 51a and the first ring gear 51c are rotating elements that are in mesh with a plurality of pinion gears that are supported by the first carrier 51b. The second differential gear mechanism 52 has, as the three rotating elements, a second sun gear (i.e., the second rotor connecting element) 52a that is drivingly connected to the second rotor 10, a second carrier (i.e., the second output connecting element) 52b that is drivingly connected to the rotor shaft 6, and a second ring gear (i.e., the second stationary element) 52c. Both the second sun gear 52a and the second ring gear 52c are rotating elements that are in mesh with a plurality of pinion gears that are supported by the second carrier 52b.

The first sun gear 51a of the first differential gear mechanism 51 is drivingly connected to the first rotor 20 by being drivingly connected (i.e., spline engaged) to the first rotor core supporting member 22 so as to rotate together with the first rotor core supporting member 22. Also, the second sun gear 52a of the second differential gear mechanism 52 is drivingly connected to the second rotor 10 by being drivingly connected (i.e., spline engaged) to the second rotor core supporting member 12 so as to rotate together with the second rotor core supporting member 12. The first carrier 51b of the first differential gear mechanism 51 and the second carrier 52b of the second differential gear mechanism 52 are both drivingly connected to the rotor shaft 6 so as to rotate together with the rotor shaft 6, and form an integrated carrier 53. The second ring gear 52c of the second differential gear mechanism 52 is held to a side wall portion 81 (i.e., a non-rotating member) of the case 80, and corresponds to the “non-displaceable stationary element” of the present invention. When the relative positions in the circumferential direction of the first rotor 20 and the second rotor 10 are adjusted, the rotational position of the first ring gear 51c is adjusted. The first ring gear 51c is held stationary except for when this adjustment is being made. That is, the first ring gear 51c corresponds to the “displaceable stationary element” of the present invention. In this example embodiment, a worm wheel 54 is formed on an outer peripheral surface of the first ring gear 51c. That is, the worm wheel 54 is integrally provided on the first ring gear 51c. The first ring gear 51c is operatively linked with the worm wheel 54 that serves as a displacing member, and thus rotates together with the worm wheel 54.

The relative position adjusting mechanism 50 includes a worm gear 55 that engages with the worm wheel 54. When this worm gear 55 rotates from the driving force of the actuator 56 that serves as the driving source, the worm wheel 54 that is in mesh with the worm gear 55 moves in the circumferential direction, and as a result, the first ring gear 51c rotates. The amount of movement of the worm wheel 54 in the circumferential direction, the amount of rotation of the first ring gear 51c, is proportional to the amount of rotation of the worm gear 55. The relative positions in the circumferential direction of the first rotor 20 and the second rotor 10 is determined according to the circumferential position of the worm wheel 54. Also, the size of the adjustment range of the relative positions in the circumferential direction of the first rotor 20 and the second rotor 10 may be set by the length of the worm wheel 54 in circumferential direction. The adjustment range of the relative positions in the circumferential direction of the first rotor 20 and the second rotor 10 while the rotary electric machine 2 is being operated is set to a range of 90 degrees or 180 degrees of electrical angle, for example.

As described above, the first carrier (i.e., the first output connecting element) 51b and the second carrier (i.e., the second output connecting element) 52b form the integrated carrier 53, and are drivingly connected so as to rotate together. Also, the second ring gear 52c is held to the case 80, so when the first ring gear 51c rotates, the first sun gear 51a rotates relative to the second sun gear 52a such that the relative positions in the circumferential direction of the first sun gear 51a and the second sun gear 52a change. The first rotor core supporting member 22 is drivingly connected to the first sun gear 51a so as to rotate together with the first sun gear 51a, and the second rotor core supporting member 12 is drivingly connected to the second sun gear 52a so as to rotate together with the second sun gear 52a. Therefore, the relative positions in the circumferential direction of the first rotor core supporting member 22 (i.e., the first rotor 20) and the second rotor core supporting member 12 (i.e., the second rotor 10) can be adjusted by adjusting the rotational position of the first ring gear 51c (i.e., the circumferential position of the worm wheel 54).

The gear ratio of the first differential gear mechanism 51 and the gear ratio of the second differential gear mechanism 52 are set such that the rotation speed of the second sun gear 52a and the rotation speed of the first sun gear 51a while the first ring gear 51c is being held stationary are equal. In this example embodiment, the first differential gear mechanism 51 and the second differential gear mechanism 52 are made to have the same diameter. Also, the gear ratio of the first differential gear mechanism 51 (=the number of teeth on the first sun gear 51a/the number of teeth on the first ring gear 51c) and the gear ratio of the second differential gear mechanism 52 (=the number of teeth on the second sun gear 52a/the number of teeth on the second ring gear 52c) are set to be the same. Further, as described above, the first carrier 51b and the second carrier 52b are integrally formed, and the first ring gear 51c and the second ring gear 52c are both held stationary except for when the rotational position of the first ring gear 51c is adjusted. According to this kind of structure, the rotation speed of the second sun gear 52a and the rotation speed of the first sun gear 51a while the first ring gear 51c is held stationary are equal to each other, and the rotation speed of the first rotor core 21 (i.e., the first rotor 20) and the rotation speed of the second rotor core 11 (i.e., the second rotor 10) are equal to each other. Therefore, the rotor 4 that is made up of the two rotors 10 and 20 rotates as a unit while the rotation phase difference (the relative position and relative phase) between the rotors is maintained, by adjusting the relative positions in the circumferential direction of the first rotor 20 and the second rotor 10. That is, the rotor 4 rotates as a unit while the relative phase (i.e., the relative rotation phase) of the rotors 10 and 20 is adjusted.

As described in the example embodiment above, technology can be provided that is able to keep induced voltage within a voltage resistance limit of an inverter, without increasing the size of a control device of a driving apparatus that controls a driving apparatus provided with a rotary electric machine that includes a rotor having permanent magnets and a stator having a coil, a field adjusting mechanism that changes a field flux supplied by the rotor, and an inverter that is connected to the coil.

### Other Example Embodiments

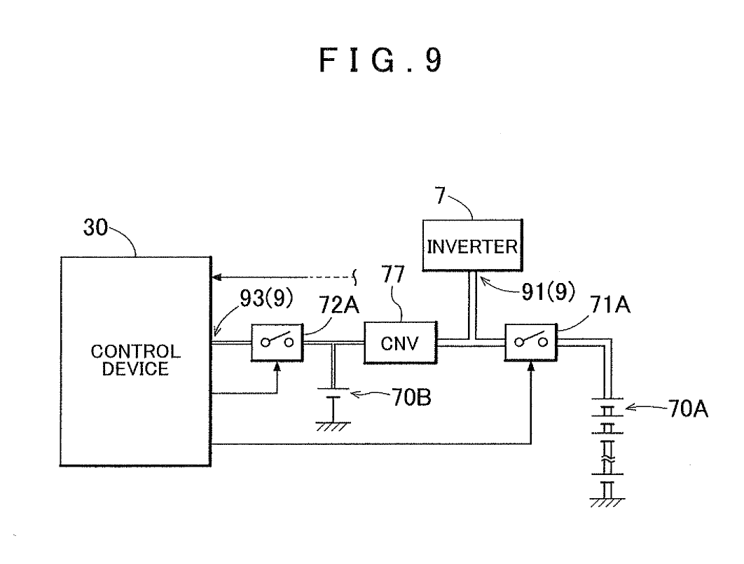

(1) In the example embodiment described above, as one preferred embodiment, as shown in FIG. 1, the sub switch 72 is provided separate from the main switch 71 that connects the power supply input portion 9 to the main power supply 70 when closed and disconnects the power supply input portion 9 from the main power supply 70 when open, and provided bypassing the main switch 71. The sub switch 72 is able to connect the power supply input portion 9 to the main power supply 70 when closed regardless of the open/closed state of the main switch 71. However, the present invention is not limited to this embodiment. A power supply circuit of an embodiment such as that shown in FIG. 9 may also be formed. In FIG. 9, the main power supply 70 in FIG. 1 is denoted by 70A (a high voltage power supply 70A), the main switch 71 is denoted by 71A, and the sub switch 72 is denoted by 72A. Also, in this embodiment, a low voltage power supply 70B that retains power stepped down via the converter 77 is also provided. A high voltage-resistant, high capacity relay or the like is used for the main switch 71A that turns the connection with the high voltage power supply 70A on and off. This kind of relay is a relatively expensive component. Therefore, as shown in the example in FIG. 1, production costs may increase if a relay having the same function as the main switch 71 is provided as the sub switch 72. With respect to this, the sub switch 72A shown in FIG. 9 turns the comedian with the stepped down low voltage power supply 70B on and off, so it is also possible to accommodate a low voltage-resistant, low capacity relay. The main power supply 70 of the present invention refers to a power supply that is a source for supplying power to the circuit, so the high voltage power supply 70A and the low voltage power supply 70B in FIG. 9 both correspond to the main power supply of the present invention.

First, the control device 30 is activated by an ignition key or a start button or the like. At this time, for example, power may be supplied to the control device from the low voltage power supply 70B by turning on a switch, not shown, or power may be supplied to the control device 30 from another path, not shown. Of course, power may also be supplied to the control device 30 from the low voltage power supply 708 by turning on the sub switch 72A. Next, a safety check, such as a check to determine whether there is an electrical leak in a high voltage power supply system that includes the high voltage power supply 70A, is performed, and if there are no problems, the main switch 71A is turned on by the control device 30.

As described above, the control device 30 controls the sub switch 72A closed if it is open, when it is determined that the induced voltage will exceed the voltage resistance Vₘₐₓ of the inverter. Also, the control device 30 controls the switching of the inverter 7 according to field-weakening control. Even if the driver performs an operation to turn off the main switch 71A in this state, such that the disconnect condition is satisfied, the control device 30 keeps the main switch 71A and the sub switch 72A closed. As a result, field-weakening control is continued. If the induced voltage is less than the voltage resistance Vₘₐₓ of the inverter, the main switch 71A is opened such that the high voltage power supply 70A is disconnected. Then, the sub switch 72A is opened and shutdown according to the disconnect condition is executed. As shown in FIG. 9, even if the main switch 71A that turns the connection with the high voltage power supply 70A on and off and the sub switch 72A that turns the connection with the low voltage power supply 70B on and off are provided, if it is determined that the overvoltage state exists when the disconnect condition is satisfied, the connection with the main power supplies 70A and 70B is maintained regardless of the disconnect condition, at least until the overvoltage state is eliminated, and the rotary electric machine 2 is controlled by field-weakening control that supplies weakened field current that weakens the field flux to the coil 3b, and the main power supplies 70A and 70B can be disconnected according to the disconnect condition after the overvoltage state has been eliminated.

(2) In the example embodiment described above, an example was described in which the field command determining portion 32 sets the field flux at which the system loss P_{LOS} is minimal as the initial field command value B₀* based on at least the target torque T* and the rotation speed ω referencing the map 32m that defines the system loss P_{LOS}, applies a limit in which the field limiting value Bₗₘₜ is the upper limit to this initial field command value B₀* and then determines the field command value B*. However, the map 32m is not limited to being a map that defines the system loss P_{LOS}, but may also be structured as a map that directly defines the initial field command value B₀* and the field command value B* with the rotation speed ω and the target torque T* as parameters. For example, the torque map shown in FIG. 5 is one preferred example of a map that forms the map 32m.

(3) In the example embodiment described above, the rotor is formed by two rotors and the field flux is changed by changing the relative positions in the circumferential direction of these two rotors. However, the present invention is not limited to this structure. The structure may also be such that the magnetic flux that reaches the stator is changed by displacing at least one portion of the rotor in the axial direction.

(4) In the example embodiment described above, the rotor and the stator are arranged overlapping in the radial direction. However, the present invention is not limited to this structure. An axial rotary electric machine in which the rotor and the stator are arranged overlapping in the axial direction may instead be used. Also, in the example embodiment described above, an inner rotor-type rotary electric machine is given as an example, but the present invention may of course also be applied to an outer rotor-type rotary electric machine.

(5) The structure of the variable magnetic flux-type rotary electric machine is not limited to the example embodiments described above. The rotary electric machine may also be an inner rotor-type or outer rotor-type rotary electric machine, in which two split rotors are arranged adjacent in the axial direction, and the relative positions in the circumferential direction of the two rotors are able to be changed. According to this kind of structure, the field flux that reaches the stator may be changed by one or both of the flux barrier and the permanent magnets of the rotors affecting each other.

(6) In the example embodiment described above, as an example of a variable magnetic flux-type rotary electric machine, permanent magnets are provided in the inner rotor, from among the outer rotor and the inner rotor, the relative positions of which can be adjusted in the circumferential direction, and a flux barrier is formed in the outer rotor. However, the present invention is not limited to this. Permanent magnets may be provided in the outer rotor and the flux barrier may be formed in the inner rotor. Also, permanent magnets may be provided in both the outer rotor and the inner rotor. Moreover, permanent magnets may be provided and a flux barrier may be formed in each rotor. The same also applies to a case in which the rotor is formed split in the axial direction. In a plurality of split rotors, permanent magnets and a flux barrier may be provided in each rotor, or in one of the rotors.

The present invention may be used for a driving apparatus or a rotary electric machine of a variable magnetic flux type that is capable of adjusting field flux by permanent magnets, as well as for a control device that controls these.

What is claimed is:

1. A control device of a driving apparatus that controls a driving apparatus that includes a rotary electric machine provided with a rotor having a permanent magnet and a stator having a coil, a field adjusting mechanism that changes a field flux supplied by the rotor, and an inverter that is connected to the coil, the control device comprising:
a power supply input portion that is connected to a direct current main power supply;
a power supply controlling portion that controls connection and disconnection between the power supply input portion and the main power supply;
a rotary electric machine controlling portion that controls the rotary electric machine via the inverter;
a disconnect condition determining portion that determines whether a disconnect condition of the main power supply is satisfied;
a field amount deriving portion that obtains an estimated field amount that is an estimated value of the field flux supplied from the rotor to the stator;
an induced voltage calculating portion that calculates an induced voltage that is induced in the coil, based on a rotation speed of the rotor and the estimated field amount; and
an overvoltage determining portion that determines whether an overvoltage state in which the induced voltage exceeds a voltage resistance of the inverter exists, wherein
if it is determined that the overvoltage state exists when the disconnect condition is satisfied, connection with the main power supply is maintained regardless of the disconnect condition, at least until the overvoltage state is eliminated, and the rotary electric machine is controlled by field-weakening control that supplies a weakened field current that weakens the field flux to the coil, and the main power supply is disconnected according to the disconnect condition after the overvoltage state has been eliminated.

2. The control device of a driving apparatus according to claim 1, further comprising:
an adjusting mechanism controlling portion that determines a field command value that serves as a target for the field flux that is adjusted by the field adjusting mechanism, based on at least the rotation speed of the rotor, with a field limiting value, that is set according to the rotation speed of the rotor within a range in which the induced voltage will not exceed the voltage resistance of the inverter, as an upper limit, and controls the field adjusting mechanism; and
an abnormality determining portion that determines an abnormality in at least one of the adjusting mechanism controlling portion and the field adjusting mechanism, wherein
when it is determined that the overvoltage state exists and it is determined by the abnormality determining portion that there is an abnormality, the power supply controlling portion maintains the connection with the main power supply regardless of the disconnect condition.

3. The control device of a driving apparatus according to claim 1, wherein
the rotary electric machine controlling portion determines a current command that is a target value for a driving current supplied to the coil, based on at least the estimated field amount, a target torque of the rotary electric machine, and the rotation speed, and controls the rotary electric machine.

4. The control device of a driving apparatus according to claim 1, wherein
the field adjusting mechanism is a mechanism that adjusts the field flux by displacing at least a portion of the rotor in a circumferential direction or a direction of a rotational axis of the rotor, and includes a driving source that supplies driving force for the displacement, and a power transmitting mechanism that transmits the driving force from the driving source to the rotor.

5. The control device of a driving apparatus according to claim 4, wherein
the rotor includes a first rotor and a second rotor that each have a rotor core and of which a relative position is adjustable, and the permanent magnet is provided in the rotor core of at least one of the rotors; and the field adjusting mechanism is a relative position adjusting mechanism that adjusts the field flux by displacing the relative position in a circumferential direction.

6. The control device of a driving apparatus according to claim 5, wherein:
the first rotor and the second rotor are both drivingly connected to a common output member;
the relative position adjusting mechanism includes, as the power transmitting mechanism, a first differential gear mechanism that has three rotating elements, and a second differential gear mechanism that has three rotating elements;
the first differential gear mechanism has, as the three rotating elements, a first rotor connecting element that is drivingly connected to the first rotor, a first output connecting element that is drivingly connected to the output member, and a first stationary element;
the second differential gear mechanism has, as the three rotating elements, a second rotor connecting element that is drivingly connected to the second rotor, a second output connecting element that is drivingly connected to the output member, and a second stationary element;
one of the first stationary element and the second stationary element serves as a displaceable stationary element that is operatively linked to the driving source, and the other serves as a non-displaceable stationary element that is held stationary by a non-rotating member; and
a gear ratio of the first differential gear mechanism and a gear ratio of the second differential gear mechanism are set such that a rotation speed of the second rotor connecting element and a rotation speed of the first rotor connecting element while the displaceable stationary element is held stationary are equal to each other.

7. The control device of a driving apparatus according to claim 1, further comprising:
a sub switch that is provided separate from a main switch that connects the power supply input portion to the main power supply when closed and disconnects the power supply input portion from the main power supply when open, and provided bypassing the main switch, and that is capable of connecting the power supply input portion to the main power supply when closed regardless of an open/closed state of the main switch, wherein
the power supply controlling portion controls the sub switch closed regardless of the disconnect condition, when it is determined that the overvoltage state exists.

8. The control device of a driving apparatus according to claim 2, wherein
the rotary electric machine controlling portion determines a current command that is a target value for a driving current supplied to the coil, based on at least the estimated field amount, a target torque of the rotary electric machine, and the rotation speed, and controls the rotary electric machine.

9. The control device of a driving apparatus according to claim 8, wherein
the field adjusting mechanism is a mechanism that adjusts the field flux by displacing at least a portion of the rotor in a circumferential direction or a direction of a rotational axis of the rotor, and includes a driving source that supplies driving force for the displacement, and a power transmitting mechanism that transmits the driving force from the driving source to the rotor.

10. The control device of a driving apparatus according to claim 9, wherein
the rotor includes a first rotor and a second rotor that each have a rotor core and of which a relative position is adjustable, and the permanent magnet is provided in the rotor core of at least one of the rotors; and the field adjusting mechanism is a relative position adjusting mechanism that adjusts the field flux by displacing the relative position in a circumferential direction.

11. The control device of a driving apparatus according to claim 10, wherein:
the first rotor and the second rotor are both drivingly connected to a common output member;
the relative position adjusting mechanism includes, as the power transmitting mechanism, a first differential gear mechanism that has three rotating elements, and a second differential gear mechanism that has three rotating elements;
the first differential gear mechanism has, as the three rotating elements, a first rotor connecting element that is drivingly connected to the first rotor, a first output connecting element that is drivingly connected to the output member, and a first stationary element;
the second differential gear mechanism has, as the three rotating elements, a second rotor connecting element that is drivingly connected to the second rotor, a second output connecting element that is drivingly connected to the output member, and a second stationary element;
one of the first stationary element and the second stationary element serves as a displaceable stationary element that is operatively linked to the driving source, and the other serves as a non-displaceable stationary element that is held stationary by non-rotating member; and
a gear ratio of the first differential gear mechanism and a gear ratio of the second differential gear mechanism are set such that a rotation speed of the second rotor connecting element and a rotation speed of the first rotor connecting element while the displaceable stationary element is held stationary are equal to each other.

12. The control device of a driving apparatus according to claim 1, further comprising:
a sub switch that is provided separate from a main switch that connects the power supply input portion to the main power supply when closed and disconnects the power supply input portion from the main power supply when open, and provided bypassing the main switch, and that is capable of connecting the power supply input portion to the main power supply when closed regardless of an open/closed state of the main switch, wherein
the power supply controlling portion controls the sub switch closed regardless of the disconnect condition, when it is determined that the overvoltage state exists.

13. The control device of a driving apparatus according to claim 2, wherein
the field adjusting mechanism is a mechanism that adjusts the field flux by displacing at least a portion of the rotor in a circumferential direction or a direction of a rotational axis of the rotor, and includes a driving source that supplies driving force for the displacement, and a power transmitting mechanism that transmits the driving force from the driving source to the rotor.

14. The control device of a driving apparatus according to claim 13, wherein
the rotor includes a first rotor and a second rotor that each have a rotor core and of which a relative position is adjustable, and the permanent magnet is provided in the rotor core of at least one of the rotors; and the field adjusting mechanism is a relative position adjusting mechanism that adjusts the field flux by displacing the relative position in a circumferential direction.

15. The control device of a driving apparatus according to claim 14, wherein:
the first rotor and the second rotor are both drivingly connected to a common output member;
the relative position adjusting mechanism includes, as the power transmitting mechanism, a first differential gear mechanism that has three rotating elements, and a second differential gear mechanism that has three rotating elements;
the first differential gear mechanism has, as the three rotating elements, a first rotor connecting element that is drivingly connected to the first rotor, a first output connecting element that is drivingly connected to the output member, and a first stationary element;
the second differential gear mechanism has, as the three rotating elements, a second rotor connecting element that is drivingly connected to the second rotor, a second output connecting element that is drivingly connected to the output member, and a second stationary element;
one of the first stationary element and the second stationary element serves as a displaceable stationary element that is operatively linked to the driving source, and the other serves as a non-displaceable stationary element that is held stationary by a non-rotating member; and
a gear ratio of the first differential gear mechanism and a gear ratio of the second differential gear mechanism are set such that a rotation speed of the second rotor connecting element and a rotation speed of the first rotor connecting element while the displaceable stationary element is held stationary are equal to each other.

16. The control device of a driving apparatus according to claim 15, further comprising:
a sub switch that is provided separate from a main switch that connects the power supply input portion to the main power supply when closed and disconnects the power supply input portion from the main power supply when open, and provided bypassing the main switch, and that is capable of connecting the power supply input portion to the main power supply when closed regardless of an open/closed state of the main switch, wherein
the power supply controlling portion controls the sub switch closed regardless of the disconnect condition, when it is determined that the overvoltage state exists.

17. The control device of a driving apparatus according to claim 3, wherein
the field adjusting mechanism is a mechanism that adjusts the field flux by displacing at least a portion of the rotor in a circumferential direction or a direction of a rotational axis of the rotor, and includes a driving source that supplies driving force for the displacement, and a power transmitting mechanism that transmits the driving force from the driving source to the rotor.

18. The control device of a driving apparatus according to claim 17, wherein
the rotor includes a first rotor and a second rotor that each have a rotor core and of which a relative position is adjustable, and the permanent magnet is provided in the rotor core of at least one of the rotors; and the field adjusting mechanism is a relative position adjusting mechanism that adjusts the field flux by displacing the relative position in a circumferential direction.

19. The control device of a driving apparatus according to claim 18, wherein:
the first rotor and the second rotor are both drivingly connected to a common output member;
the relative position adjusting mechanism includes, as the power transmitting mechanism, a first differential gear mechanism that has three rotating elements, and a second differential gear mechanism that has three rotating elements;
the first differential gear mechanism has, as the three rotating elements, a first rotor connecting element that is drivingly connected to the first rotor, a first output connecting element that is drivingly connected to the output member, and a first stationary element;
the second differential gear mechanism has, as the three rotating elements, a second rotor connecting element that is drivingly connected to the second rotor, a second output connecting element that is drivingly connected to the output member, and a second stationary element;
one of the first stationary element and the second stationary element serves as a displaceable stationary element that is operatively linked to the driving source, and the other serves as a non-displaceable stationary element that is held stationary by a non-rotating member; and
a gear ratio of the first differential gear mechanism and a gear ratio of the second differential gear mechanism are set such that a rotation speed of the second rotor connecting element and a rotation speed of the first rotor connecting element while the displaceable stationary element is held stationary are equal to each other.

20. The control device of a driving apparatus according to claim 19, further comprising:
a sub switch that is provided separate from a main switch that connects the power supply input portion to the main power supply when closed and disconnects the power supply input portion from the main power supply when open, and provided bypassing the main switch, and that is capable of connecting the power supply input portion to the main power supply when closed regardless of an open/closed state of the main switch, wherein
the power supply controlling portion controls the sub switch closed regardless of the disconnect condition, when it is determined that the overvoltage state exists.
